(19) United States
(12) Patent Application Publication
(10) Pub. No.: US 2025/0327901 A1
(43) Pub. Date: Oct. 23, 2025

(54) SENSOR MOUNTING ASSEMBLY IN VEHICLES

(71) Applicant: Honda Motor Co., Ltd., Tokyo (JP)

(72) Inventor: TIMOTHY J. RUPP, DUBLIN, OH (US)

(21) Appl. No.: 18/639,646

(22) Filed: Apr. 18, 2024

(51) Int. Cl. G01S 7/481; G01S 17/931

(52) U.S. Cl. CPC G01S 7/4813; G01S 17/931

(57) ABSTRACT

A sensor mounting assembly is provided. The sensor mounting assembly includes a cover having a first end segment and a plurality of attachment features. The first end segment is coupled to a glass roof of a vehicle. The cover is configured to enclose a sensor that is disposed proximally to the glass roof. The sensor mounting assembly further includes a bracket that is coupled to a roof rail located beneath the glass roof of the vehicle. The bracket has a first portion and a second portion. The first portion is configured to secure the sensor proximally to the glass roof of the vehicle and the second portion includes a plurality of mating features to receive the plurality of attachment features that is configured to align the cover with the bracket.

### BACKGROUND

Vehicles are equipped with a variety of sensors designed to collect diverse types of data, which is then utilized to regulate various vehicle functions. These sensors may include vision sensors such as infrared sensors, charge coupled device (CCD) sensors, complementary metal oxide semiconductor (CMOS) sensors, RADAR sensors, and LiDAR sensors. These sensors are designed to gather environmental information and use it to control the vehicle's movements. In some cases, these sensors may be strategically mounted on the vehicle's roof to maximize their field of view, thereby aiding the driver in navigating the vehicle. However, the installation of these sensors necessitates a sensor mounting assembly with at least two mounting structures, each requiring at least two datum/pin or vehicle's roof hole for individual assembly. This can complicate the assembly quality of the sensor mounting assembly. Therefore, there is a need for a refined sensor mounting assembly that includes a single mounting structure, eliminating the need for the datum/pin or vehicle's roof hole. This structure should enhance the assembly quality of the sensor mounting assembly. Furthermore, the mounting structures should be adjustable to accommodate the fit and finish of various sensor mounting assemblies.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, a sensor mounting assembly is provided. The sensor mounting assembly may include a cover having a first end segment and a plurality of attachment features. The first end segment may be coupled to a glass roof of a vehicle. The cover may be configured to enclose a sensor that may be disposed proximally to the glass roof. The sensor mounting assembly may further include a bracket that may be coupled to a roof rail located beneath the glass roof of the vehicle. The bracket may have a first portion and a second portion. The first portion may be configured to secure the sensor proximally to the glass roof of the vehicle and the second portion may include a plurality of mating features to receive the plurality of attachment features that may be configured to align the cover with the bracket.

According to an embodiment of the disclosure, a sensor mounting assembly is provided. The sensor mounting assembly may include a cover having a first end segment and a plurality of attachment features. The first end segment may be coupled to a glass roof of a vehicle. The cover may be configured to enclose a sensor that may be disposed proximally to the glass roof. The sensor mounting assembly may further include a bracket that may be coupled to a roof rail located beneath the glass roof of the vehicle. The bracket may have a first portion and a second portion. The first portion may be configured to secure the sensor proximally to the glass roof of the vehicle and the second portion may include a plurality of mating features to receive the plurality of attachment features that may be configured to align the cover with the bracket. The sensor mounting assembly may further include a portion of the bracket may be disposed on the roof rail at a first datum level from a base of the roof rail. Further, the portion of the bracket may be inserted in an opening of the roof rail such that the portion of the bracket reaches a second datum level from the base of the roof rail.

According to another embodiment of the disclosure, a method of assembling a sensor mounting assembly is provided. The method may include coupling a first end segment of a cover to a glass roof of a vehicle. The cover may be configured to enclose a sensor that is disposed proximally to the glass roof of the vehicle. The method may further include securing the sensor to a first portion of a bracket and coupling the bracket to a roof rail located beneath the glass roof of the vehicle. A second portion of the bracket having a plurality of mating features may receive a plurality of attachment features of the cover that may be configured to align the cover with the bracket.

### BRIEF DESCRIPTION OF THE DRAWINGS

FIG. 1 is a diagram that illustrates an isometric view of a sensor mounting assembly for a vehicle, in accordance with an embodiment of the disclosure.

FIG. 2 is a diagram that illustrates a cross-sectional view of the sensor mounting assembly of FIG. 1, in accordance with an embodiment of the disclosure.

FIG. 3 is a diagram that illustrates a cross-sectional view of a plurality of attachment features associated with the sensor mounting assembly of FIG. 1, in accordance with an embodiment of the disclosure.

FIG. 4 is a diagram that illustrates a cross-sectional view of a plurality of mating features associated with the sensor mounting assembly of FIG. 1, in accordance with an embodiment of the disclosure.

FIG. 5 is a diagram that illustrates a cross-sectional view of a first taper-shaped portion and a second taper-shaped portion associated with the sensor mounting assembly of FIG. 1, in accordance with an embodiment of the disclosure.

FIG. 6 is a diagram that illustrates an exemplary scenario to assemble the sensor mounting assembly of FIG. 1, in accordance with an embodiment of the disclosure.

FIG. 7 is a flowchart that illustrates an exemplary method for assembling a sensor mounting assembly, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Various embodiments of the present disclosure may be found in a sensor mounting assembly. The disclosed sensor mounting assembly may include a cover having a first end segment and a plurality of attachment features. The first end segment may be coupled to a glass roof of a vehicle. The cover may be configured to enclose a sensor that may be disposed proximally to the glass roof. The disclosed sensor mounting assembly may further include a bracket that may be coupled to a roof rail located beneath the glass roof of the vehicle. The bracket may have a first portion and a second portion. The first portion may be configured to secure the sensor proximally to the glass roof of the vehicle and the second portion may include a plurality of mating features to receive the plurality of attachment features that may be configured to align the cover with the bracket.

Traditionally, installing the sensor mounting assembly on a vehicle's roof of the vehicle has caused a number of issues. For example, if the sensor mounting assembly includes at least two mounting structures (such as a cover and a bracket) and is installed on the vehicle's roof, each of the two mounting structures must be individually assembled with the vehicle's roof using at least two datum/pin or vehicle's roof holes. Furthermore, disassembling each of the two mounting structures may complicate assembly quality of the sensor mounting assembly. Installing different sensor mounting assemblies may require distinct mounting structures that may increase an installation cost of the sensor mounting assembly.

To overcome some of the abovementioned issues, the proposed sensor mounting assembly may include only one mounting structure (for example, a mounting structure combining a cover and a bracket) that may be installed on the vehicle's roof. The installation of such sensor mounting assembly requires one datum/pin or vehicle's roof hole on the vehicle's roof, which improves assembly quality of the proposed sensor mounting assembly. The mounting structure must be tunable or adjustable to allow fit and finish of different sensor mounting assemblies to reduce assembly cost of sensor mounting assembly.

Reference will now be made in detail to specific aspects or features, examples of which are illustrated in the accompanying drawings. Wherever possible, corresponding, or similar reference numbers will be used throughout the drawings to refer to the same or corresponding parts.

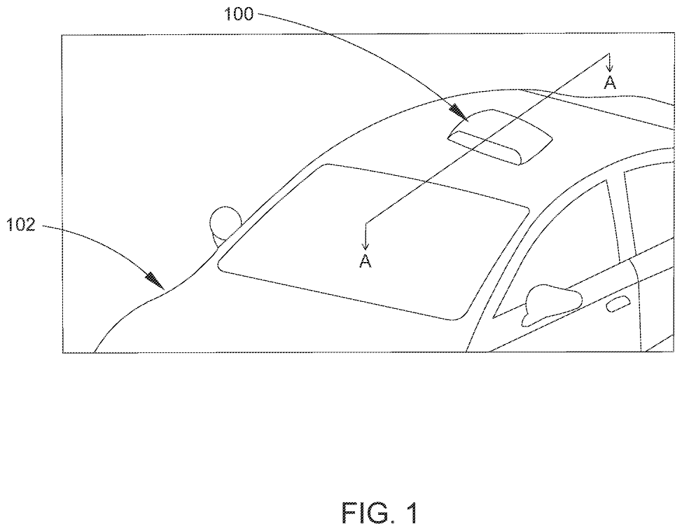

FIG. 1 is a diagram that illustrates an isometric view of a sensor mounting assembly for a vehicle, in accordance with an embodiment of the disclosure. With reference to FIG. 1, there is shown a sensor mounting assembly 100 for a vehicle 102.

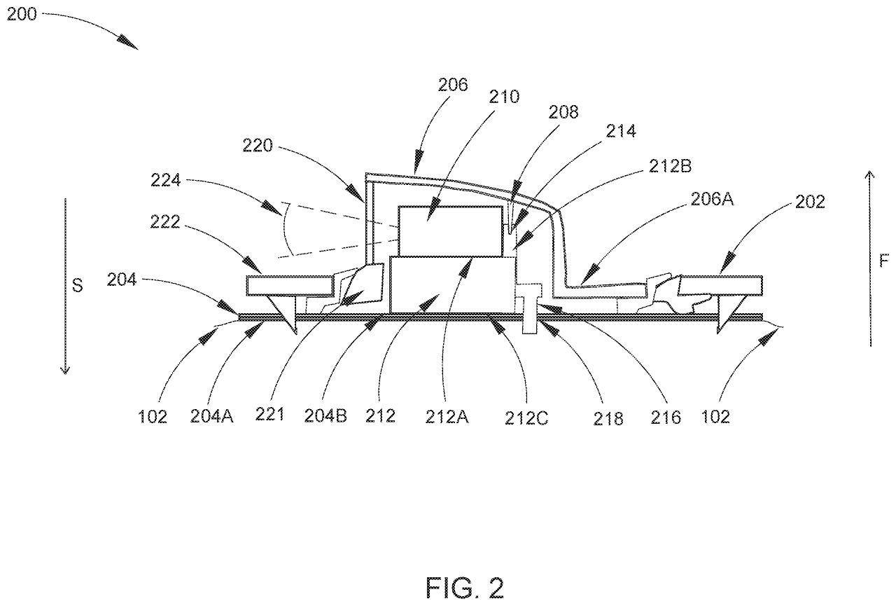

The sensor mounting assembly 100 may have a suitable design, shape, and structure, which may be configured to secure a sensor (as shown in FIG. 2) of the vehicle 102. In some instances, the sensor mounting assembly 100 may include multiple components (as shown in FIG. 2), for example, a cover and a bracket. The cover may be configured to enclose the sensor of the vehicle 102 and the bracket may be configured to hold and secure the sensor of the vehicle 102. Details of the cover and the bracket are further provided, for example, in FIG. 2.

In an example embodiment, the sensor mounting assembly 100 may be located on a top surface (for example, a vehicle's roof) of the vehicle 102. Additionally, or alternatively, the sensor mounting assembly 100 may be located on a frontal portion of the top surface of the vehicle 102. In order to enhance aerodynamics of the vehicle 102, the sensor mounting assembly 100 may typically have a significantly curved profile. It should be noted that the sensor mounting assembly 100 may incorporate any structural profile; for instance, a rectangular profile, a square profile, a polygonal profile, or something similar. The significantly arcuate profile is merely an example. The structural profile of the sensor mounting assembly 100 may vary in accordance with user requirements and vehicle's structural characteristics.

The vehicle 102 may be a non-autonomous vehicle, a semi-autonomous vehicle, or a fully autonomous vehicle, for example, as defined by National Highway Traffic Safety Administration (NHTSA) or Society of Automotive Engineers (SAE) automation levels. Examples of the vehicle 102 may include, but are not limited to, a single-wheeled vehicle, a two-wheeled vehicle, a three-wheeled vehicle, a four-wheeled vehicle, or a multi-wheeled vehicle. It should be noted here that the vehicle 102 shown in FIG. 1 is merely an example four-wheeler vehicle and such an example should not be construed as limiting the disclosure. The present disclosure may also be applicable to other types of vehicles, such as, two-wheeled vehicles (for example, a scooter) or three-wheeled vehicles, and the like. The description of other types of the vehicle 102 has been omitted from the disclosure for the sake of brevity.

The vehicle 102 may include a plurality of sensors (not shown) that may be configured to detect various forms of data and the data may be used to control various aspects of the vehicle 102. The data may also be used to assist a driver operating the vehicle 102.

The sensor mounting assembly 100 and vehicle 102 of FIG. 1 are illustratively cut along a first section A-A (as shown in FIG. 2) to describe additional components.

FIG. 2 is a diagram that illustrates a cross-sectional view of the sensor mounting assembly of FIG. 1, in accordance with an embodiment of the disclosure. FIG. 2 is described in conjunction with elements from FIG. 1. With reference to FIG. 2, there is shown a cross-sectional view 200 of the sensor mounting assembly 100 and the vehicle 102, which may be sectioned along the first section A-A of FIG. 1. The sensor mounting assembly 100 may include a glass roof 202, a roof rail 204 having a first surface 204A and a second surface 204B, a cover 206 having a first end segment 206A, a plurality of attachment features 208, a sensor 210, a bracket 212 having a first portion 212A, a second portion 212B, and a base portion 212C, a plurality of mating features 214, a portion 216 of the bracket 212, an opening 218, a viewing window 220, a second end segment 221 of the cover 206, a front windshield 222, and a field-of-view 224 for the sensor 210.

The glass roof 202 of the vehicle 102 may be disposed on a roof (for example, a top surface) of the vehicle 102, the roof rail 204 beneath the glass roof 202, and an interior cabin (not shown) to accommodate an occupant or an operator of the vehicle 102. The glass roof 202 may be a panel that may be fastened to the roof of the vehicle 102. In an embodiment, the glass roof 202 may be fixedly coupled to the roof of the vehicle 102. In another embodiment, the glass roof 202 may be a movable panel that may be attached to the roof of the vehicle 102 via a moveable coupling. Alternatively, the glass roof 202 may be a fixed panel that includes a moveable section, such that the moveable section of the glass roof 202 may be moveably coupled to the roof of the vehicle 102. In accordance with user preference, the glass roof 202 may be produced as a tinted or transparent panel. Additionally, or alternatively, the roof rail 204 may provide support for the glass roof 202.

The roof rail 204 may be long bars that run along a length of the vehicle's roof, from a front portion to a rear portion of the vehicle 102. The roof rail 204 may include a plurality of rails which may be secured to the roof of the vehicle 102. The roof rail 204 may be located beneath the glass roof 202 and may be configured to secure components of the sensor mounting assembly 100. Additionally, the roof rail 204 may also be configured to secure other objects (for example, a cargo) on the roof of the vehicle 102, so that there is an increased space in the interior cabin (not shown) of the vehicle 102. The roof rail 204 may further include a first surface 204A and a second surface 204B. The second surface 204B may be different from the first surface 204A of the roof rail 204. For example, the first surface 204A of the roof rail 204 may be substantially planar to a horizontal plane. The second surface 204B of the roof rail 204 may be substantially planar to the first surface 204A. In some instances, the second surface 204B of the roof rail 204 may be identical to the first surface 204A.

The cover 206 may include a suitable design, shape, and structure, which may be configured to enclose the sensor 210. By way of example, and not limitation, the cover 206 may form a substantially arcuate shape or enclosure that may be configured to enclose the sensor 210 disposed proximally to the glass roof 202. Such substantially arcuate shape or enclosure of the cover 206 may protect the sensor 210 from dust or debris. The cover 206 may be disposed on the roof of the vehicle 102. Specifically, the cover 206 may be secured to the glass roof 202 of the vehicle 102. Additionally, or alternatively, the cover 206 may be secured by a combination of the glass roof 202 and the roof rail 204 of the vehicle 102. The cover 206 may include a first end segment 206A that may be coupled with the glass roof 202 of the vehicle 102. The cover 206 may further include the plurality of attachment features 208, the viewing window 220, and the second end segment 221.

The first end segment 206A may include a suitable design, shape, and structure, which may form an integral substructure (for example, a foundation) for the cover 206. The first end segment 206A may have a horizontal structure as shown in FIG. 2. The horizontal structure of the first end segment 206A is merely provided as an example. The first end segment 206A may have other shapes, including but not limited to, C, V, H, U, or similar shapes. The first end segment 206A may be coupled to the glass roof 202 of the vehicle 102. In some instances, the first end segment 206A may be a fixed coupling member (such as a fixed flange), which may be coupled with the glass roof 202 of the vehicle 102. In certain instances, the first end segment 206A may be a removable coupling member (such as a removable flange), which may be coupled with the glass roof 202 of the vehicle 102. As an example, the first end segment 206A may be formed at a rear end or a front end of the sensor mounting assembly 100. Alternatively, the first end segment 206A may be formed on both the rear end and the front end of the sensor mounting assembly 100.

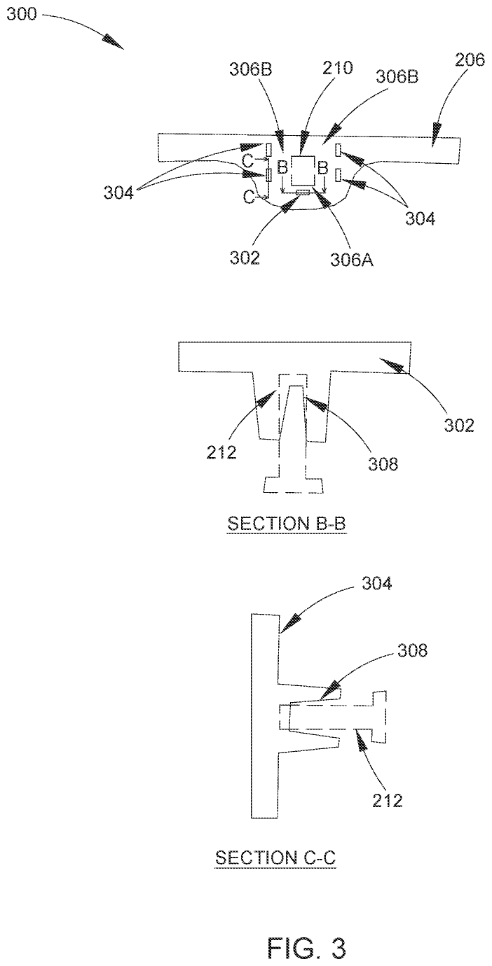

The plurality of attachment features 208 may be a protrusion or an extension that may extend from a section (not shown) of the cover 206. The plurality of attachment features 208 may include a suitable design, shape, and structure. For instance, the plurality of attachment features 208 may be substantially perpendicular to the section of the cover 206 that may allow the plurality of attachment features 208 to interact with the bracket 212. In some embodiments, the plurality of attachment features 208 may be gripped onto the bracket 212 to align datum levels between the bracket 212 and the cover 206. By way of example, and not limitation, the plurality of attachment features 208 may have a substantially circular profile, which may enable a smooth movement inside a portion (for example, a plurality of mating features 214) of the bracket 212 that may have a substantially circular profile. Further, each of the plurality of attachment features 208 may have a taper-shaped portion that extend from the section of the cover 206, as explained in detail, for example, in FIG. 3.

The sensor 210 may include a suitable circuitry, logic, and network interfaces, which may be disposed proximally to the glass roof 202 of the vehicle 102. The sensor 210 may be configured to capture an image or a plurality of images of one or more objects in an environment surrounding the vehicle 102. The sensor 210 may include a 360-degree camera, which may capture a 360-degree view of the surrounding environment of the vehicle 102. In an embodiment, the 360-degree camera may be a single 360-degree camera, which may capture the 360-degree view of the surrounding environment. In another embodiment, the sensor 210 may include a plurality of image sensors (not shown) to capture the 360-degree view of the surrounding environment of the vehicle 102. Each image sensor of the plurality image sensors may capture a portion of the 360-degree view of the surrounding environment of the vehicle 102. In an embodiment, the sensor 210 (i.e., the 360-degree camera) may stitch each captured portion of the plurality image sensors to generate the 360-degree view of the surrounding environment of the vehicle 102. The sensor 210 (such as the 360-degree camera) may be disposed on the bracket 212.

In a preferred embodiment, the sensor 210 may be a LIDAR sensor that has a field-of-view 224. The field-of-view 224 may include a horizontal field-of-view of the sensor 210 along a horizontal plane between 1-360 degrees. The field-of-view 224 may further include a vertical field-of-view of the sensor 210 along a vertical plane between 1-45 degrees. The LiDAR sensor may perform a 360-degrees scan of the surrounding environment to identify a target object. For example, the target object may be identified-based on an emission of a laser illumination on the target object and a time taken to receive a reflected laser illumination from the target object. In another embodiment, the sensor 210 may be a RADAR sensor or a combination of RADAR and LiDAR sensor.

The bracket 212 may include a suitable design, shape, and structure, which may be coupled to the roof rail 204 that may be located beneath the glass roof 202 of the vehicle 102. The bracket 212 may be secured to the second surface 204B of the roof rail 204. In certain embodiments, the bracket 212 may be coupled to the roof rail 204 from the interior cabin (not shown) of the vehicle 102. The bracket 212 may have a substantially L-shaped profile or may have other shapes, including but not limited to, a rectangular shape, a square shape, a hexagonal shape, or a circular shape. The substantially L-shaped profile of the bracket 212 may have a first portion 212A, a second portion 212B, and a base portion 212C. The first portion 212A may be configured to secure the sensor 210 proximally to the glass roof 202 of the vehicle 102.

The first portion 212A may include a suitable design, shape, and structure, which may be configured to secure the sensor 210. For example, the first portion 212A may have a substantially flat surface, which may be configured to secure the sensor 210. The first portion 212A may also have other surface textures, such as a corrugated surface to improve fixation of the sensor 210 against the first portion 212A of the bracket 212. In an embodiment, the first portion 208B may be disposed at a first height (not shown) from the roof rail 204 in a first direction “F”. The first direction “F” may be measured from a bottom surface to a top surface of the vehicle 102 in a vertical plane. In an embodiment, the first portion 212A may be integrally connected to the second portion 212B to form the bracket 212. For example, the first portion 212A and the second portion 212B may be formed from the same material and manufactured as a unitary element. In another embodiment, the first portion 212A may be releasably connected to the second portion 212B to form the bracket 212.

The second portion 212B of the bracket 212 may include a suitable design, shape, and structure, which includes a plurality of mating features 214 that may be configured to receive the plurality of attachment features 208 to align the cover 206 with the bracket 212. The second portion 212B may be an extension that may extend from the first portion 212A in the first direction “F”. In an embodiment, the second portion 212B may be disposed at a second height (not shown) from the roof rail 204 in the first direction “F”. In an embodiment, the second height may be lesser than the first height. In another embodiment, the second height may be higher than the first height. In yet another embodiment, the second height may be same as the first height.

The second portion 212B may be integrally connected to the first portion 212A to form the bracket 212. For example, the first portion 212A and the second portion 212B may be formed from the same material and manufactured as a unitary element. In another example, the second portion 212B may be formed from a material that may be different from a material of the first portion 212A. In another embodiment, the second portion 212B may be releasably connected to the first portion 212A to form the bracket 212.

The base portion 212C of the bracket 212 may be disposed on the roof rail 204 and may extend towards a second direction “S” of the first portion 212A and the second portion 212B of the bracket 212. The second direction “S” may be different from the first direction “F”. For example, the second direction “S” may be substantially opposite to the first direction “F” of the first portion 212A of the bracket 212. In another example, the second direction “S” may be substantially same as the first direction “F” of the first portion 212A of the bracket 212.

The base portion 212C may have a substantially flat surface, which may be configured to secure the bracket 212 to the roof rail 204. Alternatively, the base portion 212C may have other surface textures, such as a corrugated surface to improve fixation of the base portion 212C of the bracket 212 against the roof rail 204. Additionally, the base portion 212C may be secured to the roof rail 204 from the interior cabin (not shown) of the vehicle 102.

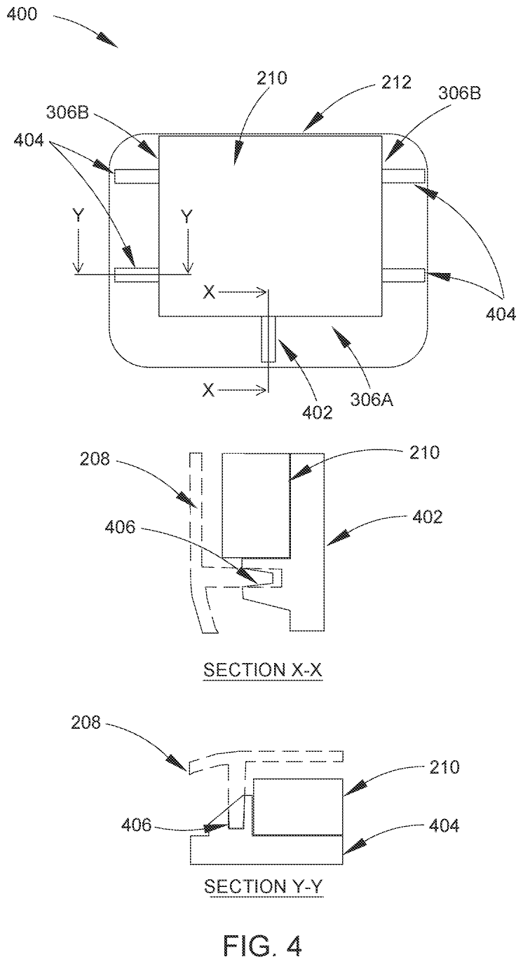

The plurality of mating features 214 may include a suitable design, shape, and structure, which may indent from a surface (not shown) of the bracket 212. The plurality of mating features 214 are configured to receive the plurality of attachment features 208 to align the cover 206 with the bracket 212. For example, each mating feature of the plurality of mating features 214 may have a funnel shape that may receive an attachment feature of the plurality of attachment features 208. For instance, the plurality of mating features 214 may be substantially perpendicular to the surface (not shown) of the bracket 212 that may allow the plurality of attachment features 208 to be secured inside the bracket 212. By way of example, and not limitation, the plurality of mating features 214 may have a substantially circular profile, which may enable a smooth movement of the plurality of attachment features 208 inside the plurality of mating features 214 of the bracket 212. Further, each of the plurality of mating features 214 may have a taper-shaped portion that indent from the surface (not shown) of the bracket 212, as explained in detail, for example, in FIG. 4.

The portion 216 of the bracket 212 may include a suitable design, shape, and structure, which may extend from the second portion 212B of the bracket 212. The portion 216 of the bracket 212 may be located substantially perpendicular to the base portion 212C of the bracket 212. In an example, the portion 216 of the bracket 212 may have a substantially L-shaped profile that may extend in the second direction “S” of the base portion 212C of the bracket 212. In certain instances, the portion 216 may have a different shape, such as but not limited to, a rectangular shape, a square shape, a hexagonal shape, or a circular shape. The portion 216 of the bracket 212 may be disposed on the roof rail 204 at a first datum level (not shown) from a base (not shown) of the roof rail 204. As an example, the first datum may be at a first height (not shown) from the base of the roof rail 204 measured in the first direction “F” of the first portion 212A of the bracket 212. The portion 216 of the bracket 212 may be inserted in an opening 218 of the roof rail 204 such that the portion 216 of the bracket 212 reaches a second datum from the base of the roof rail 204. As an example, the second datum may be at a second height (not shown) from the base of the roof rail 204 measured in the first direction “F” of the first portion 212A of the bracket 212. As another example, the second datum may be at the second height from the base of the roof rail 204 measured in the second direction “S” of the base portion 212C of the bracket 212. The second direction “S” may be substantially opposite to the first direction “F” of the first portion 212A of the bracket 212. The portion 216 of the bracket 212 provides one datum for the sensor mounting assembly 100 that results in removing multiple datums on the roof rail 204 of the vehicle 102, which may improve assembly quality of the sensor mounting assembly 100.

The viewing window 220 may be configured to allow the field-of-view 224 for the sensor 210. The field-of-view 224 may include at least one of the horizontal field-of-view and the vertical field-of-view for the sensor 210. As an example, the viewing window 220 may be configured to allow a combination of the horizontal field-of-view and the vertical field-of-view for the sensor 210. In another example, the viewing window 220 may be disposed at a proximal end of the cover 206 and may facilitate the at least one of the horizontal field-of-view and the vertical field-of-view for the sensor 210. By way of example, but not limitation, the viewing window 220 may be formed from a transparent material (such as a glass material, a quartz material, a sapphire material, and the like). By way of another example, but not limitation, the viewing window 220 may be tinted based on a user preference. For example, the viewing window 220 may be tinted using a specific color, which may be similar to a color of a painted coating on a surface of the vehicle 102. Such tinting of the viewing window 220 may improve aesthetics of the vehicle 102.

The viewing window 220 may include the second end segment 221, which may be secured to a portion (not shown) of the front windshield 222 of the vehicle 102. For example, the second end segment 221 may form a seal against the portion of the front windshield 222 and may protect the sensor 210 against ingress of fluids (such as via the rainfall or other liquids) and the ingress of dust particles from the surrounding environment of the vehicle 102. In another example, the viewing window 220 may be coupled to the cover 206 and may form a secondary seal to protect the sensor 210 against the ingress of fluids (such as via the rainfall or other liquids) and the ingress of dust particles from the surrounding environment of the vehicle 102. It should be noted here that the second end segment 221 of the cover 206 is shown in FIG. 1B as a block, which is merely an example that should not construed as limiting the disclosure. However, the second end segment 221 of the cover 206 may have any structural profile, such as a rod, a sphere, or any other polygonal shape, based on user requirements and/or a level of sealing that may be required for the sensor 210 in the sensor mounting assembly 100.

The vehicle 102 may also include the front windshield 222. The front windshield 222 may be a transparent screen, which may be formed from a laminated safety glass that may protect the occupants and/or the operator of the vehicle 102 from wind, dust, or any debris that may be enter the vehicle 102 from the surrounding environment. The front windshield 222 may also provide a structural support to the vehicle 102. It should be noted here that the front windshield 222 shown in FIG. 2 is presented merely as an example of a generic windshield and further description of the front windshield 222 has been omitted from the disclosure for the sake of brevity. The front windshield 222 of the vehicle 102 may be secured to the first surface 204A of the roof rail 204.

FIG. 3 is a diagram that illustrates a cross-sectional view of a plurality of attachment features associated with the sensor mounting assembly of FIG. 1, in accordance with an embodiment of the disclosure. FIG. 3 is explained in conjunction with elements from FIG. 1 and FIG. 2. With reference to FIG. 3, there is shown an exemplary diagram 300 that shows the plurality of attachment features 208 that includes a primary attachment feature 302, a plurality of secondary attachment features 304, a rear side 306A and other sides 306B of the sensor 210, and a first taper-shaped portion 308.

The plurality of attachment features 208 may include the primary attachment feature 302 which may be a protrusion or an extension that may extend from a section (not shown) of the cover 206. Further, the primary attachment feature 302 is illustratively cut along a section B-B. The primary attachment feature 302 may include a suitable design, shape, and structure. The primary attachment feature 302 may be located on the rear side 306A of the sensor 210. For instance, the primary attachment feature 302 may be substantially perpendicular to the section of the cover 206 that may allow the primary attachment feature 302 to interact with the bracket 212 on the rear side 306A of the sensor 210. The primary attachment feature 302 may be configured to lock datum levels of the bracket 212 on the rear side 306A of the sensor 210. Locking the datum levels of the bracket 212 on the rear side 306A of the sensor 210 may improve the assembly quality of the sensor mounting assembly 100.

The plurality of attachment features 208 may further include the plurality of secondary attachment features 304 which may be a protrusion or an extension that may extend from the section of the cover 206. Each secondary attachment feature of the plurality of secondary attachment features 304 is illustratively cut along the section C-C. Each secondary attachment feature of the plurality of secondary attachment features 304 may be located around other sides 306B of the sensor 210. For instance, the plurality of secondary attachment features 304 may be substantially perpendicular to the section of the cover 206 that may allow each secondary attachment feature of the plurality of secondary attachment features 304 to interact with the bracket 212 around other sides 306B of the sensor 210. Each secondary attachment feature of the plurality of secondary attachment features 304 are configured to guide the cover 206 in the bracket 212 around other sides 306B of the sensor 210.

Further, the primary attachment feature 302 may be larger than each secondary attachment feature of the plurality of secondary attachment features 304. As an example, a length the primary attachment feature 302 may be larger than a length of each secondary attachment feature of the plurality of secondary attachment features 304. As another example, the length the primary attachment feature 302 may be equal to the length of each secondary attachment feature of the plurality of secondary attachment features 304. In another example, the length of the primary attachment feature 302 may be less than the length of each secondary attachment feature of the plurality of secondary attachment features 304.

Each of the plurality of attachment features 208 may include a first taper-shaped portion 308 that may extend from the section of the cover 206. Further, the primary attachment feature 302 and each secondary attachment feature of the plurality of secondary attachment features 304 may include the first taper-shaped portion 308. The first taper-shaped portion 308 may be configured to guide the cover 206 in the bracket 212 and may allow each of the plurality of attachment features 208 to slide in the each of the plurality of mating features 214 to guide the cover 206 in the bracket 212.

FIG. 4 is a diagram that illustrates a cross-sectional view of a plurality of mating features associated with the sensor mounting assembly of FIG. 1, in accordance with an embodiment of the disclosure. FIG. 4 is explained in conjunction with elements from FIG. 1, FIG. 2, and FIG. 3. With reference to FIG. 4, there is shown an exemplary diagram 400 that shows the plurality of mating features 214 that includes a primary mating feature 402, a plurality of secondary mating features 404, and a second taper-shaped portion 406.

The plurality of mating features 214 may include the primary mating feature 402 which may indent from a surface (not shown) of the bracket 212. Further, the primary mating feature 402 is illustratively cut along a section X-X. The primary mating feature 402 may include a suitable design, shape, and structure. The primary mating feature 402 may be located at the rear side 306A of the sensor 210. For instance, the primary mating feature 402 may be substantially perpendicular to the surface (not shown) of the bracket 212 that may allow the primary attachment feature 302 of the cover 206 to be secured inside the bracket 212 on the rear side 306A of the sensor 210. The primary mating feature 402 may receive the primary attachment feature 302 that is configured to lock datum levels of the bracket 212 on the rear side 306A of the sensor 210. Additionally, locking the datum levels of the bracket 212 on the rear side 306A of the sensor 210 improve the assembly quality of the sensor mounting assembly 100.

The plurality of mating features 214 may further include the plurality of secondary mating features 404 which may indent from the surface (not shown) of the bracket 212. Further, each secondary mating feature of the plurality of secondary mating features 404 is illustratively cut along the section Y-Y. Each secondary mating feature of the plurality of secondary mating features 404 may include a suitable design, shape, and structure. Each secondary mating feature of the plurality of secondary mating features 404 may be located around other sides 306B of the sensor 210. For instance, the plurality of secondary mating features 404 may be substantially perpendicular to the surface (not shown) of the bracket 212 that may allow each secondary mating feature of the plurality of secondary mating features 404 to receive each secondary attachment feature of the plurality of secondary attachment features 304 around other sides 306B of the sensor 210. Each secondary mating feature of the plurality of secondary mating features 404 are configured to guide the cover 206 in the bracket 212 around other sides 306B of the sensor 210.

Further, each of the plurality of mating features 214 may include a second taper-shaped portion 406 that may indent from the surface (not shown) of the bracket 212. Further, the primary mating feature 402 and each secondary mating feature of the plurality of secondary mating features 404 may include the second taper-shaped portion 406. The second taper-shaped portion 406 may be configured to receive the first taper-shaped portion 308 of the plurality of attachment features 208. The second taper-shaped portion 406 may allow each of the plurality of mating features 214 to receive each of the plurality of attachment features 208 to guide the cover 206 in the bracket 212.

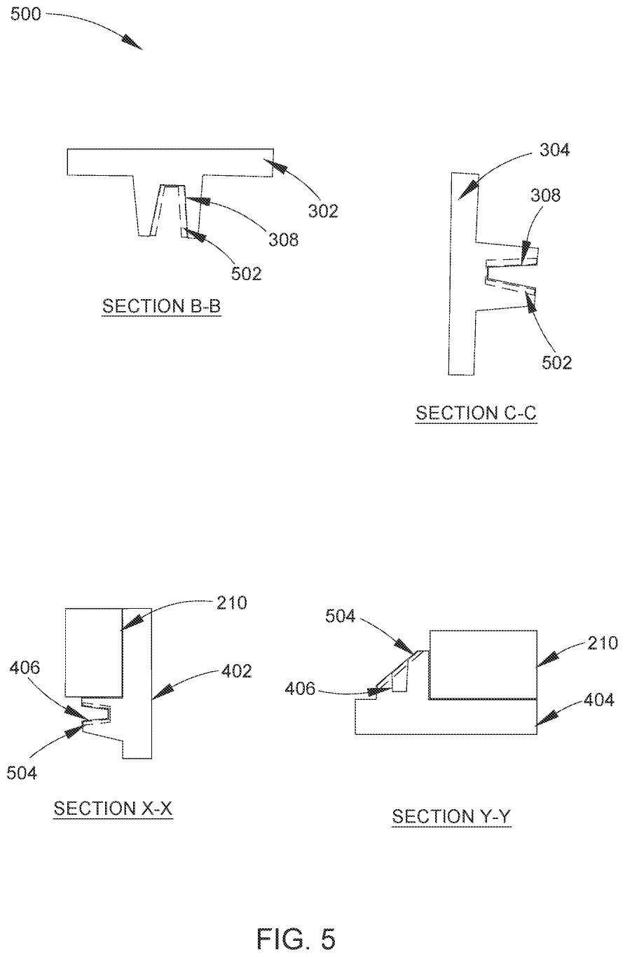

FIG. 5 is a diagram that illustrates a cross-sectional view of a first taper-shaped portion and a second taper-shaped portion associated with the sensor mounting assembly of FIG. 1, in accordance with an embodiment of the disclosure. FIG. 5 is explained in conjunction with elements from FIG. 1, FIG. 2, FIG. 3, and FIG. 4. With reference to FIG. 5, there is shown an exemplary diagram 500 that shows a cross-sectional view of the first taper-shaped portion 308 having an excess cutting area 502. The exemplary diagram 500 further shows a cross-sectional view of the second taper-shaped portion 406 having an adjustable area 504.

The excess cutting area 502 of the first taper-shaped portion 308 may be an extension that may extend from the first taper-shaped portion 308. The excess cutting area 502 of the first taper-shaped portion 308 may be configured to secure the plurality of attachment features 208 with the bracket 212. The excess cutting area 502 may be used to tune or adjust dimensions of the first taper-shaped portion 308 to secure the plurality of attachment features 208 of varied sizes with the plurality of mating features 214 of the bracket 212.

The adjustable area 504 of the second taper-shaped portion 406 may be an extension that may extend from the second taper-shaped portion 406. The adjustable area 504 of the second taper-shaped portion 406 of each secondary mating feature of the bracket 212 may be configured to receive the first taper-shaped portion 308 of a corresponding attachment feature of the cover 206. The adjustable area 504 may be used to tune or adjust dimensions of the second taper-shaped portion 406 to secure the plurality of attachment features 208 of varied sizes with the plurality of mating features 214 of the bracket 212.

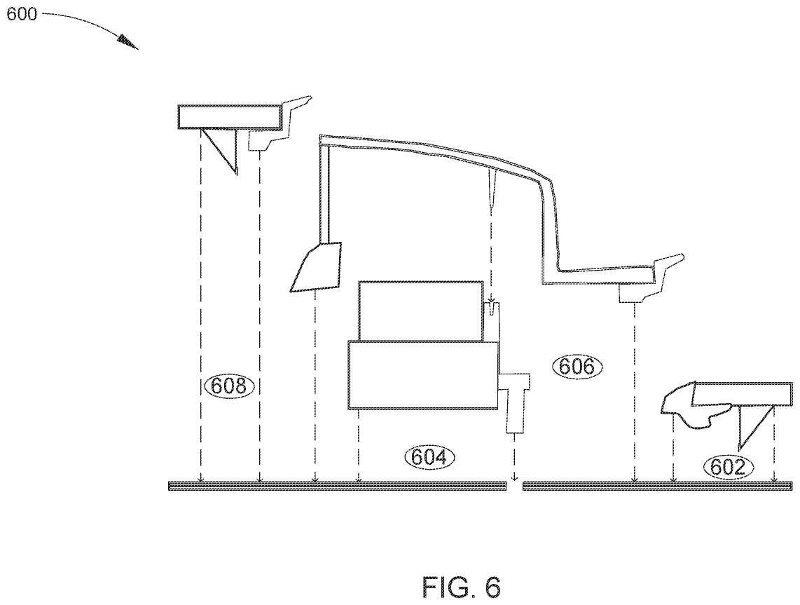

FIG. 6 is a diagram that illustrates an exemplary scenario to assemble the sensor mounting assembly of FIG. 1, in accordance with an embodiment of the disclosure. FIG. 6 is explained in conjunction with elements from FIG. 1, FIG. 2, FIG. 3, FIG. 4, and FIG. 5. With reference to FIG. 6, there is shown an exemplary operation scenario 600 to assemble the sensor mounting assembly 100. The exemplary operation scenario 600 may include a plurality of operations to assemble the sensor mounting assembly 100. The plurality of operations may include, for example, a first operation 602, a second operation 604, a third operation 606, and a fourth operation 608.

In the first operation 602, the glass roof 202 (shown in FIG. 2) may be configured to be coupled to the roof rail 204 of the vehicle 102. In an embodiment, the operator may couple the glass roof 202 to the roof rail 204 of the vehicle 102, as described further, for example, in FIG. 2.

In the second operation 604, the portion 216 (shown in FIG. 2) of the bracket 212 may be configured to be coupled with the opening 218 of the roof rail 204 of the vehicle 102. In an embodiment, the operator may couple the portion 216 of the bracket 212 with the opening 218 of the roof rail 204, as described further, for example, in FIG. 2. In another embodiment, the sensor 210 may be pre-assembled with the bracket 212 to form an assembled component (not shown), and the assembled component may be coupled with the opening 218 of the roof rail 204 using the portion 216 of the bracket 212 to mount the sensor 210 proximally to the glass roof 202 of the vehicle 102.

In the third operation 606, the plurality of attachment features 208 (shown in FIG. 2) of the cover 206 may be configured to be coupled with the plurality of mating features 214 of the bracket 212. In an embodiment, the operator may couple the plurality of attachment features 208 within the plurality of mating features 214, as described further, for example, FIG. 2.

In the fourth operation 608, the front windshield 222 (shown in FIG. 2) may be configured to be coupled with the second end segment 221 of the cover 206 to seal the sensor 210 disposed on the first portion 212A of the bracket 212. In an embodiment, the operator may couple the front windshield 222 with the second end segment 221 (shown in FIG. 2) of the cover 206 to seal the sensor 210 disposed on the first portion 212A of the bracket 212, as described further, for example, in FIG. 2.

The plurality of operations shown in FIG. 6 is illustrated as discrete operations, such as from 602 to 608, which relates to the plurality of operations to assemble the sensor mounting assembly 100. However, in certain embodiments, such discrete operations may be further divided into additional operations, combined into fewer operations, or eliminated, depending on the implementation without detracting from the scope of the disclosed embodiments.

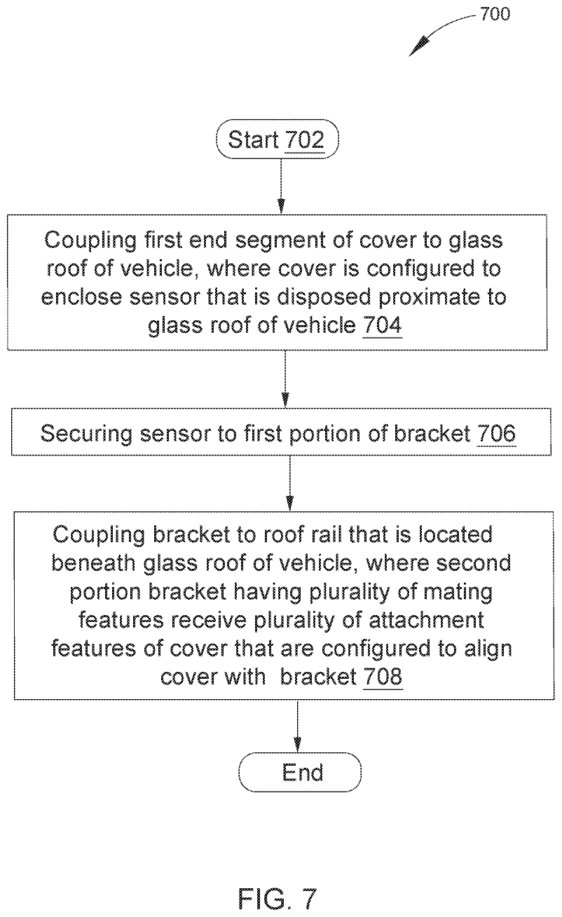

FIG. 7 is a flowchart that illustrates an exemplary method for assembling a sensor mounting assembly, in accordance with an embodiment of the disclosure. FIG. 7 is explained in conjunction with elements from FIG. 1, FIG. 2, FIG. 3, FIG. 4, FIG. 5, and FIG. 6. With reference to FIG. 7, there is shown a flowchart 700. The method illustrated in the flowchart 700 may start at 702 and proceed to 704.

At 704, the first end segment 206A of the cover 206 may be coupled to the glass roof 202 of the vehicle 102. The cover 206 is configured to enclose the sensor 210 disposed proximally to the glass roof 202 of the vehicle 102, as described further, for example, in FIG. 1, FIG. 2, FIG. 3, and FIG. 4.

At 706, the sensor 210 may be secured to the bracket 212. Further, the bracket 212 may have the first portion 212A that is configured to secure the sensor 210, as described further, for example, in FIG. 1, FIG. 2, FIG. 3, and FIG. 4.

At 708, the bracket 212 may be coupled to the roof rail 204 located beneath the glass roof 202 of the vehicle 102. The bracket 212 may have the second portion 212B having the plurality of mating features 214 to receive the plurality of attachment features 208 of the cover 206 that are configured to align the cover 206 with the bracket 212, as described further, for example, in FIG. 1, FIG. 2, FIG. 3, and FIG. 4.

The flowchart shown in FIG. 7 is illustrated as discrete operations, such as from 704 to 708, which relates to the method of assembling the sensor mounting assembly 100. However, in certain embodiments, such discrete operations may be further divided into additional operations, combined into fewer operations, or eliminated, depending on the implementation without detracting from the essence of the disclosed embodiments.

For the purposes of the present disclosure, expressions, such as “including”, “comprising”, “incorporating”, “consisting of”, “have”, “is”, used to describe and claim the present disclosure, are intended to be construed in a non-exclusive manner, namely allowing for items, components or elements not explicitly described also to be present. Reference to the singular is also to be construed to relate to the plural. Further, all joinder references (e.g., attached, coupled, connected, o the like) are used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A sensor mounting assembly, comprising:
a cover having a first end segment and a plurality of attachment features, wherein the first end segment is coupled to a glass roof of a vehicle, and the cover is configured to enclose a sensor that is disposed proximally to the glass roof; and
a bracket coupled to a roof rail that is located beneath the glass roof of the vehicle, wherein the bracket has a first portion and a second portion,
the first portion is configured to secure the sensor proximally to the glass roof of the vehicle, and
the second portion includes a plurality of mating features to receive the plurality of attachment features that is configured to align the cover with the bracket.

2. The sensor mounting assembly according to claim 1, wherein
each of the plurality of attachment features includes a first taper-shaped portion that extend from a section of the cover, and
the first taper-shaped portion is configured to guide the cover in the bracket.

3. The sensor mounting assembly according to claim 2, wherein the first taper-shaped portion has an excess cutting area that is configured to secure the plurality of attachment features with the bracket.

4. The sensor mounting assembly according to claim 1, wherein the plurality of attachment features comprises a primary attachment feature and a plurality of secondary attachment features.

5. The sensor mounting assembly according to claim 4, wherein
the primary attachment feature is located on a rear side of the sensor, and
each secondary attachment features of the plurality of secondary attachment features is located around other sides of the sensor.

6. The sensor mounting assembly according to claim 4, wherein the primary attachment feature is larger than each secondary attachment feature of the plurality of secondary attachment features.

7. The sensor mounting assembly according to claim 4, wherein
the primary attachment feature is configured to lock datum levels of the bracket on a rear side of the sensor, and
each secondary attachment feature of the plurality of secondary attachment features are configured to guide the cover in the bracket around other sides of the sensor.

8. The sensor mounting assembly according to claim 1, wherein
each of the plurality of mating features includes a second taper-shaped portion that indents from a surface of the bracket, and
the second taper-shaped portion is configured to receive a first taper-shaped portion of the plurality of attachment features.

9. The sensor mounting assembly according to claim 8, wherein the second taper-shaped portion of each of the plurality of mating features includes an adjustable area that is configured to receive the first taper-shaped portion of each of the plurality of attachment features and is configured to secure the cover to the bracket.

10. The sensor mounting assembly according to claim 1, the plurality of mating features comprises a primary mating feature and a plurality of secondary mating features.

11. The sensor mounting assembly according to claim 10, wherein
the primary mating feature is located on a rear side of the sensor, and
each secondary mating feature of the plurality of secondary mating features is located around other sides of the sensor.

12. The sensor mounting assembly according to claim 10, wherein
the primary mating feature receives the primary attachment feature that is configured to lock datum levels of the bracket on a rear side of the sensor, and
each secondary mating feature of the plurality of secondary mating features receives each secondary attachment feature of a plurality of secondary attachment features that are configured to guide the cover in the bracket around other sides of the sensor.

13. The sensor mounting assembly according to claim 1, wherein,
a portion of the bracket is disposed on the roof rail at a first datum level from a base of the roof rail, and
the portion of the bracket is inserted in an opening of the roof rail such that the portion of the bracket reaches a second datum level from the base of the roof rail.

14. The sensor mounting assembly according to claim 13, wherein the portion of the bracket is located substantially perpendicular to a base portion of the bracket.

15. The sensor mounting assembly according to claim 1, wherein the sensor is a LIDAR sensor that has a horizontal field-of-view between 1-360 degrees and a vertical field-of-view between 1-45 degrees.

16. The sensor mounting assembly according to claim 1, wherein the cover has a viewing window to allow at least one of a horizontal field-of-view and a vertical field-of-view for the sensor.

17. The sensor mounting assembly according to claim 16, wherein the viewing window has a second end segment, which is secured to a portion of a front windshield of the vehicle.

18. The sensor mounting assembly according to claim 17, wherein the front windshield of the vehicle is secured to a first surface of the roof rail and the bracket is secured to a second surface of the roof rail, and wherein the second surface is substantially planar to the first surface.

19. A sensor mounting assembly, comprising:
a cover having a first end segment and a plurality of attachment features, wherein the first end segment is coupled to a glass roof of a vehicle, and the cover is configured to enclose a sensor that is disposed proximally to the glass roof;
a bracket coupled to a roof rail that is located beneath the glass roof of the vehicle, wherein the bracket has a first portion and a second portion,
the first portion is configured to secure the sensor proximally to the glass roof of the vehicle, and
the second portion includes a plurality of mating features to receive the plurality of attachment features that is configured to align the cover with the bracket; and
a portion of the bracket is disposed on the roof rail at a first datum level from a base of the roof rail, and
the portion of the bracket is inserted in an opening of the roof rail such that the portion of the bracket reaches a second datum level from the base of the roof rail.

20. A method for assembling a sensor mounting assembly, comprising:
coupling a first end segment of a cover to a glass roof of a vehicle, wherein the cover is configured to enclose a sensor that is disposed proximally to the glass roof of the vehicle;
securing the sensor to a first portion of a bracket; and
coupling the bracket to a roof rail that is located beneath the glass roof of the vehicle, wherein a second portion the bracket having a plurality of mating features receive a plurality of attachment features of the cover that are configured to align the cover with the bracket.
